(19) United States
(12) Patent Application Publication
(10) Pub. No.: US 2013/0093704 A1
(43) Pub. Date: Apr. 18, 2013

(54) EXTENSION DEVICE

(71) Applicant: ASUSTek COMPUTER INC., Taipei (TW)

(72) Inventors: Kuo-Chung CHIU, Taipei (TW); Hsiao-Kai LI, Taipei (TW); Wen-Chieh TSENG, Taipei (TW); Ming-Hsin WEI, Taipei (TW); Chih-Hung CHUANG, Taipei (TW); Ping-Cheng HSIEH, Taipei (TW)

(73) Assignee: ASUSTEK COMPUTER INC., Taipei (TW)

(21) Appl. No.: 13/646,458

(22) Filed: Oct. 5, 2012

Related U.S. Application Data
(60) Provisional application No. 61/548,053, filed on Oct. 17, 2011.

(51) Int. Cl. G06F 3/041

(52) U.S. Cl. 345/173

(57) ABSTRACT

An extension device is applied to an electronic device with a touch interface. The extension device includes an input unit, a sensing unit and a processing unit. The sensing unit connects to the touch interface and is coupled to the input unit. The processing unit includes a detecting area disposed on the touch interface corresponding to the sensing unit. When an external force is applied to the input unit, the sensing unit is relatively enabled to output a signal, and the processing unit receives the signal and transforms the signal into an execute instruction.

### CROSS REFERENCE TO RELATED APPLICATIONS

The non-provisional patent application claims priority to U.S. provisional patent application with Ser. No. 61/548,053 filed on Oct. 17, 2011. This and all other extrinsic materials discussed herein are incorporated by reference in their entirety.

### BACKGROUND OF THE INVENTION

1. Field of Invention

The disclosure relates to an extension device and, in particular, to an extension device for a portable electronic device.

2. Related Art

The tablet computer is compact and configured with a touch panel as the basic input device, so it is very convenient for the user. Therefore, the tablet computers are very popular in recent years. Currently, the tablet computer is usually equipped with a sensitive capacitive touch panel (multi-touch technology), which is used to detect the touch position based on the induced current. The induced current is caused by the capacitance variation, which is generated as the human body contacts the transparent electrodes arranged on the panel surface. Accordingly, the user can easily operate the tablet computer by fingers, such as to click, write, zoom-in/zoom-out a screen or picture, etc. However, these operations are virtual inputs and may cause undesired/unintentional inputs.

The common extension device for tablet computers is a protection cover, which can accommodate the tablet computer for providing the protection function, and some other assistant functions such as decoration and supporting. Some extension devices also provide a joystick for enhancing the operation. In general, the joystick is attached to the panel sensing area of the tablet computer by the sucking disc or the likes. However, the joystick fixed by the sucking disc usually blocks the screen and may be easily detached while playing a game. In addition, the positions and sizes of the sensing areas may be different for various applications, so that the user must prepare corresponding extension devices with respect to different applications. Moreover, it is necessary to find out the corresponding sensing area, for each application, and different applications usually have different sensing areas. This is very inconvenient.

### SUMMARY OF THE INVENTION

The present disclosure provides an extension device applied to an electronic device with a touch interface. The extension device comprises an input unit, a sensing unit and a processing unit. The sensing unit connects to the touch interface and is coupled to the input unit. The processing unit includes a detecting area disposed on the touch interface corresponding to the sensing unit. When an external force is applied to the input unit, the sensing unit is relatively enabled to output a signal, and the processing unit receives the signal and transforms the signal into an execute instruction.

The present disclosure may configure two sensing modules. The first sensing module defects an input operation of a user on the input unit (e.g. shooting a photo), and the second sensing module detects the function or action corresponding to the input operation (e.g. zoom-in or zoom-out). The first and second sensing modules both include a plurality of sensing units, so that different sensing units can be triggered with respect to the corresponding functions. Thus, this disclosure can provide a single electronic communication interface and is benefit for the mass production of the extension devices of the electronic device. In addition, this disclosure can also provide the function of preventing undesired/unintentional touch event.

The present disclosure also provides an extension device comprises an input unit, a constant-frequency sensing unit, an encoding sensing unit and a processing unit. The constant-frequency sensing unit is connected to the touch interface and coupled to the input unit for outputting a constant-frequency signal. The encoding sensing unit is connected to the touch interface and coupled to the input unit for outputting an encoded signal. The processing unit includes a detecting area disposed on the touch interface corresponding to the constant-frequency sensing unit and the encoding sensing unit. When an external force is applied to the input unit, the constant-frequency sensing unit and the encoding sensing unit are relatively enabled to output the constant-frequency signal and the encoded signal, respectively, and the processing unit receives the constant-frequency signal and the encoded signal and transforms them into an execute instruction.

The present disclosure may configure two sensing units. One of the sensing units outputs the constant-frequency signal as a reference, and the other sensing unit outputs the encoded signal according to the specific code of the input unit in the conventional art, when the finger slides upwardly on the touch interface, the electronic device should receive an “Up”, instruction. However, the electronic device may misunderstand this operation very often. In this disclosure, each button of the input unit is defined with a specific code, and the inputted instruction is not determined based or the hand gesture, so that the misunderstanding of the input operation can be prevented. The configuration of two sensing units is very simple and can provide a single electronic communication interface, so that it is benefit to the mass production of extension devices.

These and other features, aspects and advantages of the present disclosure will become better understood with regard to the following description, appended claims, and accompanying drawings.

### BRIEF DESCRIPTION OF THE DRAWINGS

FIG. 1 is a schematic diagram showing an extension device according to a first embodiment of the disclosure, wherein the extension device is applied to a touch interface;

FIG. 2 is a system block diagram of the extension device of FIG. 1;

FIG. 3 is a schematic diagram showing an extension device according to a second embodiment of the disclosure;

FIG. 4A is a schematic diagram showing the extension device of FIG. 3 applied to a camera function;

FIG. 4B is a schematic diagram showing the extension device of FIG. 3 applied to a camera function;

FIG. 4C is a schematic diagram showing the extension device of FIG. 3 applied to a camera function;

FIG. 5A is a schematic diagram showing an extension device according to a third embodiment of the disclosure; and

FIG. 5B is a schematic diagram showing a constant-frequency signal and several encoded signals of FIG. 5A.

### DETAILED DESCRIPTION OF THE INVENTION

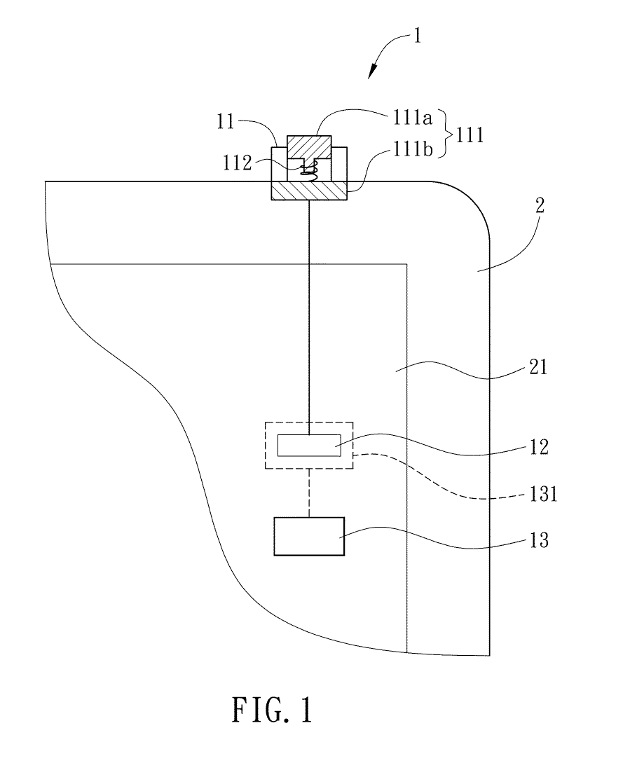

FIG. 1 is a schematic diagram showing an extension device 1 according to a first embodiment of the disclosure. Referring to FIG. 1, the extension device 1 is applied to an electronic device 2 with a touch interface 21. The extension device 1 includes an input unit 11, a sensing unit 12 and a processing unit 13. The sensing unit 12 is connected to the touch interface 21 and coupled to the input unit 11. The input unit 11 and the sensing unit 12 are link-operated. When an external force is applied to the input unit 11, the sensing unit 12 is relatively enabled to output a signal 14 to the electronic device 2. The sensing unit 12 is attached at the edge of the touch interface 2, so that the sensing unit 12 will not block the touch interface 2 in operation.

The input unit 11 includes a pressing portion 111. In this embodiment, the pressing portion 111 is made of metal material and includes a pressing portion 111a and a pressing portion 111b. In addition, an elastic element 112 is provided to connect the pressing portions 111a and 111b. In practice, the extension device 1 of the disclosure is a protection cover of an electronic device 2. Thus, the extension device 1 is entirely installed on the electronic device 2, and the input unit 11 will not be detached from the electronic device 2 during operation.

The tablet computer is usually equipped with a sensitive capacitive touch panel, which is to detect the touch position based on the induced current. The induced current is caused by the capacitance variation generated as the human body contacts the transparent electrodes arranged on the panel surface. In this embodiment, the pressing portion 111 is made of metal material. When the user presses the pressing portion 111, the pressing portions 111a and 111b contact with each other, so that the user's finger is electrically conducted with the touch interface 21. Thus, the capacitance around the sensing unit 12 is changed, and a current is generated accordingly. When the user releases the pressing portion 111a, the elastic element 112 pushes and separates the pressing portions 111a and 111b. In an embodiment, the elastic element 112 includes a spring structure. However, this disclosure is not limited to the embodiment and the elastic element 112 can be any elastic component (e.g. a rubber or piston) to separate the pressing portions 111a and 111b.

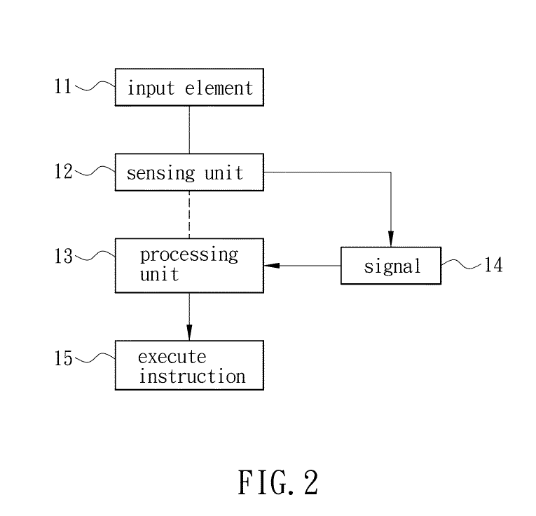

The processing unit 13 includes a defecting area 131 disposed on the touch interface 21 corresponding to the sensing unit 12. In practice, the processing unit 13 is an application. When programming the application, the position of the detecting area 131 is designed to be disposed on the touch interface 21 and located corresponding to the sensing unit 12. The detecting area 131 is configured to receive a signal 14 outputted by the sensing unit 12. FIG. 2 is a system block diagram of the extension device 1 of FIG. 1. With reference to FIG. 2, when the input unit 11 is pressed, the sensing unit 12 is relatively enabled to output a signal 14, and the processing unit 13 receives the signal 14 and transforms it into an execute instruction 15. The execute instruction 15 controls a function of the electronic device 2.

In practice, the user downloads and installs the application (the processing unit 13) before installing or operating the extension device 1. When the extension device 1 is applied to a camera function, the sensing unit 12 will correspondingly output a shooting signal as the input unit 11 is pressed/touched. Afterwards, the processing unit 13 receives and reads the shooting signal and then transforms it into a shooting instruction for enabling a photo shooting action. In addition, it is possible to configure more input units 11 as well as corresponding sensing units 12 and detecting areas 131, so that the extension device 1 enables more functions of the electronic device 2, such as zoom-in and zoom-out. Since the user is able to directly press the input unit 11 to enable the corresponding function, the operation becomes more comfortable.

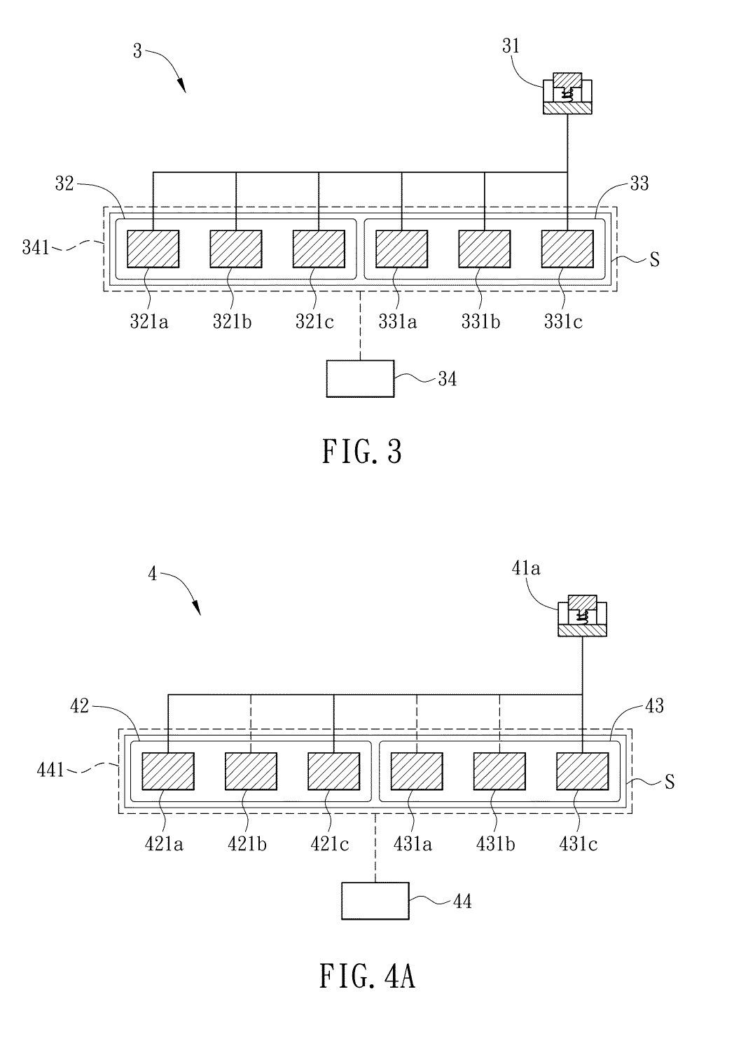

FIG. 3 is a schematic diagram showing an extension device 3 according to a second embodiment of the disclosure. Different from the first embodiment, the sensing unit S of the extension device 3 of the second embodiment includes two sensing modules. In other words, the extension device 3 of the second embodiment includes an input unit 31, a processing unit 34, and a sensing unit S composed of a first sensing module 32 and a second sensing module 33. The input unit 31 is partially made of metal material, which is similar to the first embodiment, so the detailed description thereof will be omitted. The first sensing module 32 and the second sensing module 33 are disposed on the touch interface and coupled with the input unit 31. The processing unit 34 includes a detecting area 341 corresponding to the sensing unit S, which is similar to the first embodiment, so the detailed description thereof will be omitted.

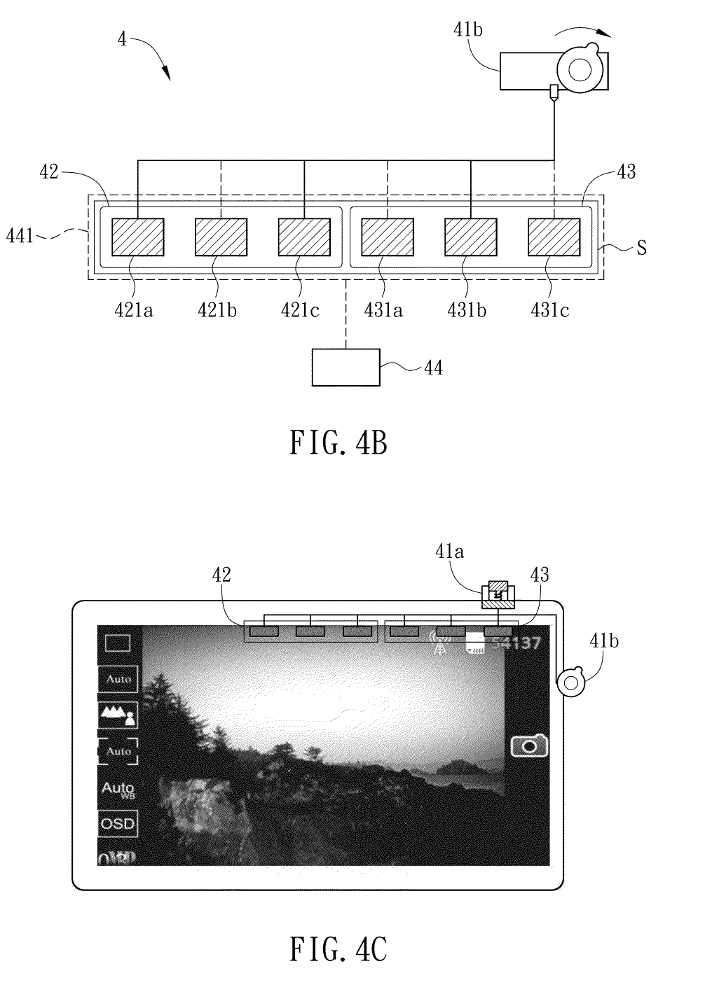

Each of the first sensing module 32 and the second sensing module 33 includes a plurality of sensing elements. In this disclosure, the first sensing module 32 includes three first sensing elements 321a, 321b and 321c for outputting a first signal, which defines the function of the input unit 31. In more detailed, the first signal defines a certain conducting circumstance of the first sensing elements as a corresponding function. For example, when the first sensing elements 321a and 321c are conducted (the solid lines represent the conducted status), the first signal defines that the input unit 131 is a camera. Besides, the second sensing module 33 includes three second sensing elements 331a, 331b and 331c for outputting a second signal, which indicates the function or action to be executed by the input unit 31. For example, when the second sensing element 331c is conducted, the electronic device performs a photo shooting action. The function of the input unit 31 is determined according to the conductive modes of the first sensing module 32 and the second sensing module 33. The practice example will be described hereinafter with reference to FIGS. 4A and 4B.

FIGS. 4A and 4B are schematic diagrams showing the extension device of FIG. 3 applied to a camera. To be noted, the code “1” represents the conductive status of the sensing unit, and the code “0” represents the non-conductive status of the sensing unit. The first signal of “101” outputted by the first sensing module 42 enables a camera, and the second signal of “001” outputted by the second sensing module 43 enables a photo shooting action (see FIG. 4A). Accordingly, when the input unit 41a is pressed, the first sensing elements 421a and 421c and the second sensing element 431c are conducted (represented by solid lines), and the first sensing element 421b and the second sensing elements 431a and 431b are non-conducted (represented by dotted lines). After the detecting area 441 receives the conductive signals, the processing unit 44 reads the signals and determines that the first signal of “101” indicates a camera function, and the second signal of “001” indicates a photo shooting action. Then, the processing unit 44 outputs an instruction to command the camera device to execute a photo shooting action. Otherwise, the second signal of “010” outputted by the second sensing module 43 enables an image zoom-in (see FIG. 4B), and the first sensing module 42 still outputs the first signal of “101” to enable a camera. When the input unit 41a is dragged to right, the second sensing element 431b is conducted and the second sensing elements 431a and 431c are non-conducted. Accordingly, after receiving and reading the signals, the processing unit 44 outputs an instruction to command the camera device to execute an image zoom-in function.

Accordingly, the present disclosure encodes the first and second sensing modules based on the function to be executed, and designs the corresponding conductive modes of the sensing units to execute the function. In the above embodiment, the sensing module is composed of three sensing elements, but this is not to limit the present disclosure. The number of the sensing elements for composing a sensing module is determined according to the desired coding level. In addition, different input units are applied to the same interface of the first and second-sensing modules (see FIG. 4C), so that they include the same electronic communication interface. The universal electronic communication interface is suitable for mass production and is benefit to the manufacturer.

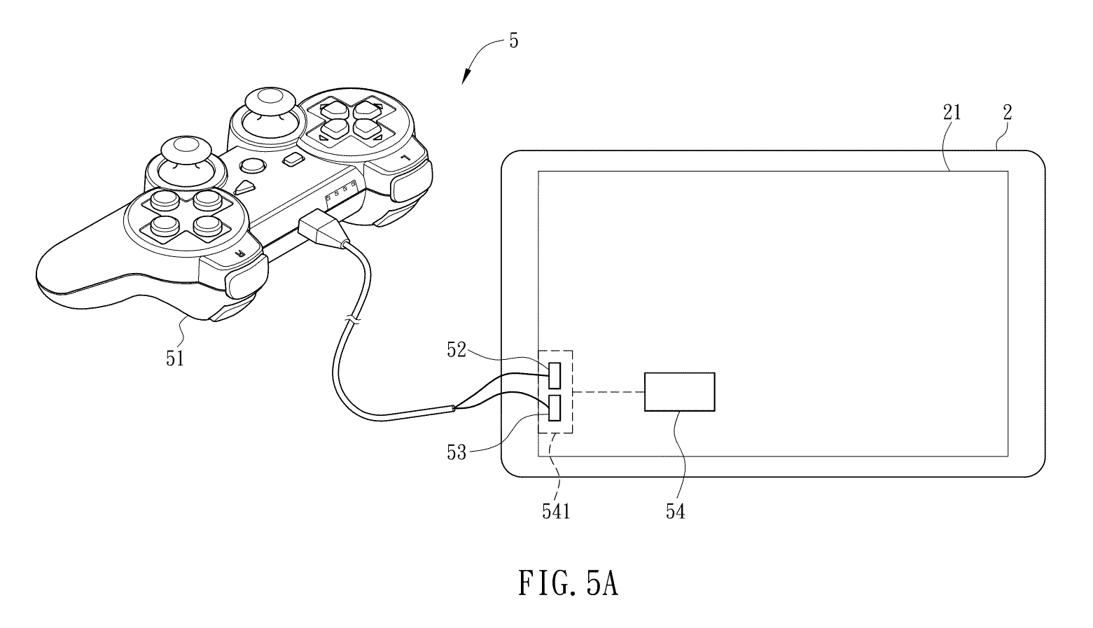

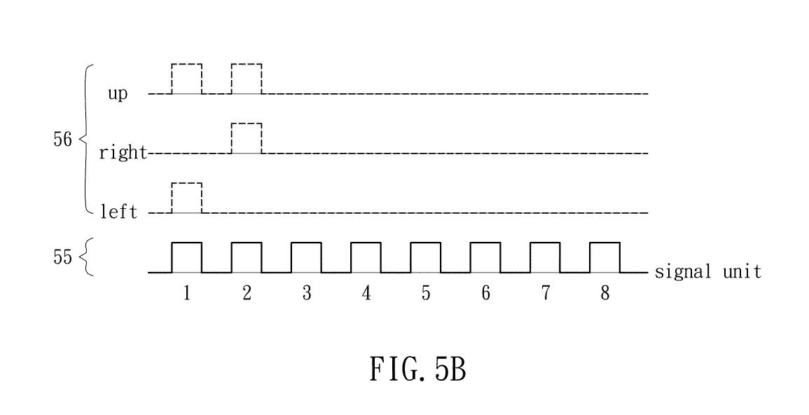

FIGS. 5A and 5B are schematic diagrams showing an extension device 5 according to a third embodiment of the disclosure. Referring to FIGS. 5A and 5B, the extension device 5 includes an input unit 51, a constant-frequency unit 52, an encoding sensing unit 53, and a processing unit 54. The structures and connections of most components are the same as the first and second embodiments, so they are not described again. The different feature of the third embodiment is that the sensing unit includes the constant-frequency unit 52 and the encoding sensing unit 53. Besides, the generated signals (see FIG. 5B) are also different. The constant-frequency unit 52 is connected to the touch interface and coupled to the input unit 51 for outputting a constant-frequency signal 55. The consent-frequency signal 55 includes a plurality of signals with the same time intervals, and it is used as a reference. The encoding sensing unit 53 is connected to the touch interface and coupled to the input unit 51 for outputting an encoded signal 56. The input unit 51 includes a specific code, and the encoded signal is generated according to the specific code.

In this embodiment, the input unit 51 is a joystick, and the constant-frequency signal 55 includes 8 signal units in constant frequency within 1/1000 seconds. The encoded signal 56 is designed corresponding to the input unit 51. For example, the left key corresponds to a specific code “10000000”, wherein “1” represents the conducted status, and “0” represents the non-conducted status. Accordingly, when the left key of the input unit 51 is pressed/touched, the constant-frequency unit 52 outputs a constant-frequency signal with 8 signal units, and the encoding sensing unit 53 is conducted in the first signal unit and non-conducted in the residual signal units, thereby outputting an encoded signal of “10000000”. Similarly, the right key corresponds to a specific code “01000000”. When the right key of the input unit 51 is pressed/touched, the encoding sensing unit 53 is conducted in the second signal unit and non-conducted in the residual signal units, thereby outputting an encoded signal of “01000000”. Moreover, when the up key is defined as “11000000”, the encoding sensing unit 53 is conducted in the first and second signal units and non-conducted in the residual signal units.

Similarly, the detecting area 541 receives the constant-frequency signal 55 and the encoded signal 56. Then, after reading and determining the received signals, the processing-unit 54 outputs an instruction to the application (e.g. game software) to enable the corresponding action. As mentioned above, the extension device 5 of the third embodiment includes a common electronic communication interface, and the coding method is applied to 256 kinds of functional keys. Herein, “1” represents the conductive status, “0” represents the non-conductive status, and 8 signal units are provided, so that there are totally 256 possible codes. This feature is applied to complex extension devices such as keyboard, music player, or the likes. In addition, since the touch interface of the current tablet computer usually includes multi-touch design (8-10 points), the design of two sensing units (the constant-frequency sensing unit and the encoding sensing unit) achieves the multiple player application. For example, 4-5 players can use the joystick to play a game at the same time.

In summary, the extension device of the disclosure includes an input unit and a sensing unit. The input unit is disposed at the periphery of the electronic device and coupled to the sensing unit, which is disposed at the edge of the touch interface, thereby inputting an instruction through the sensing unit. Thus, the screen is not blocked. In addition, the input unit is not attached to the touch interface, so that the unstably arrangement and loosing issue of the conventional art can be prevented.

The present disclosure further configures two sensing modules. Since they have a universal electronic communication interface, it is benefit to the mass production of the extension device of the electronic device. In addition, the present disclosure further includes the function of preventing undesired/unintentional touch event. Besides, two sensing units with signal encoding design are applied to complex extension device for multiple players, and they also have a universal electronic communication interface, which is benefit to the mass production of the extension device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fail within the true scope of the invention.

What is claimed is:

1. An extension device applied to an electronic device, wherein the electronic device comprises a touch interface, the extension device comprising:
an input unit;
a sensing unit connecting to the touch interface and coupled to the input unit; and
a processing unit comprising a detecting area disposed on the touch interface corresponding to the sensing unit;
wherein, when an external force is applied to the input unit, the sensing unit is relatively enabled to output a signal, and the processing unit receives the signal and transforms the signal into an execute instruction.

2. The extension device of claim 1, wherein the input unit comprises a pressing portion.

3. The extension device of claim 1, wherein the sensing unit is configured at an edge of the touch interface.

4. The extension device of claim 1, wherein the sensing unit comprises a first sensing module and a second sensing module both connected to the touch interface and coupled to the input unit for outputting a first signal and a second signal.

5. The extension device of claim 4, wherein the first sensing module comprises a plurality of first sensing elements, and the second sensing module comprises a plurality of second sensing elements.

6. An extension device applied to an electronic device, wherein the electronic device comprises a touch interface, the extension device comprising:
an input unit;
a constant-frequency sensing unit connecting to the touch interface and coupled to the input unit for outputting a constant-frequency signal;
an encoding sensing unit connecting to the touch interface and coupled to the input unit for outputting an encoded signal; and
a processing unit comprising a detecting area disposed on the touch interface corresponding to the constant-frequency sensing unit and the encoding-sensing unit;
wherein, when an external force is applied to the input unit, the constant-frequency sensing unit and the encoding sensing unit are relatively enabled to output the constant-frequency signal and the encoded signal, respectively, and the processing unit receives the constant-frequency signal and the encoded signal and transforms them into an execute instruction.

7. The extension device of claim 6, wherein the constant-frequency signal comprises a plurality of signals with the same time intervals.

8. The extension device of claim 6, wherein the input unit comprises a specific code.

9. The extension device of claim 8, wherein the encoding sensing unit outputs the encoded signal corresponding to the specific code.

10. The extension device of claim 6, wherein the constant-frequency sensing unit and the encoding sensing unit are configured at an edge of the touch interface.
